(19) United States
(12) Patent Application Publication
(10) Pub. No.: US 2006/0133805 A1
(43) Pub. Date: Jun. 22, 2006

(54) Apparatus and method for detecting light source causing optical beat interference in subcarrier multiple access optical network

(76) Inventors: Seung-Hyun Jang, Jejudo (KR); Chul-Soo Lee, Daejeon (KR); Eui-Suk Jung, Daejeon (KR); Byoung Whi Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/154,255

(22) Filed: Jun. 15, 2005

(30) Foreign Application Priority Data
Dec. 16, 2004 (KR) 10- 2004-0107094
Apr. 28, 2005 (KR) 10-2005-0035528

(51) Int. Cl. H04B 10/08

(52) U.S. Cl. 398/26

(57) ABSTRACT

An apparatus for detecting a light source causing OBI noise in an SCMA optical network. Subcarrier power meters in the apparatus measure powers of subcarrier signals obtained by filtering a multiplexed optical signal transmitted from the subscriber terminals. A OBI power meter measures OBI noise power from an output of an optical receiver that receives the multiplexed optical signal. A noise occurrence determination unit sequentially changes output powers of light sources in the subscriber terminals if the minimum SNR between the subcarrier signal powers and the OBI noise power is less than a reference SNR, and determines that a light source, which causes a change in the OBI noise power in response to the change in the output power of the light source, is an OBI-causing light source.

### RELATED APPLICATION

The present application is based on, and claims priority from, Korean Application Number 2004-0107094, filed Dec. 16, 2004, and Korean Application Number 2005-0035528, filed Apr. 28, 2005, the disclosures of which are incorporated by reference herein in its entirety.

### BACKGROUND OF THE INVENTION

1. Field of the Invention

The present invention relates to a subcarrier multiple access (SCMA) optical network, and more particularly to an apparatus and method for detecting a light source causing optical beat interference (OBI) noise in an SCMA optical network when an optical receiver in a central office receives two or more optical signals from a plurality of subscriber terminals.

2. Description of the Related Art

Recently, a Digital Subscriber Line (DSL) technology based on Unshielded Twisted Pair (UTP) and a Cable Modem Termination System (CMTS) technology based on Hybrid Fiber Coaxial (HFC) are widely used as technologies for transmitting information through communication systems. However, it is expected that it will be difficult for the DSL or CMTS technology to provide sufficient bandwidth and QoS in providing subscribers with voice/data/broadcast-integrated services that will be in widespread use in a few years. To cope with this problem, studies are underway throughout the world into Fiber To The Home (FTTH), which brings fiber optic connections directly to the subscriber level.

Optical networks have received a great deal of attention as next-generation subscriber access networks for the information age. A point-to-point optical network can provide a large amount of data to subscribers with high security. Despite this advantage, the point-to-point optical network has not yet been commercialized due to severe implementation costs.

One economical optical network is a point-to-multipoint optical network that allows a number of subscribers to share a single optical fiber and decreases network implementation costs per subscriber. One point-to-multipoint optical network is a Subcarrier Multiple Access (SCMA) optical network.

FIG. 1 is a block diagram of a general SCMA optical network.

As shown in FIG. 1, the SCMA optical network 100 includes a central office 110, an optical coupler 130, and a plurality of subscribers 120-1, 120-2, 120-N that are connected to the central office 110 via the optical coupler 130 through an optical fiber 140.

Different subcarriers are allocated to the plurality of subscribers 120-1, 120-2, . . . 120-N, each of which loads information on a subcarrier allocated to the subscriber and transmits it using an internal light source (not shown). Signals transmitted from the plurality of subscribers 120-1, 120-2, . . . 120-N are multiplexed through the optical coupler 130, and the multiplexed signal is then transmitted to the central office 110 via the optical fiber 140. In this manner, the subscribers 120-1, 120-2, . . . 120-N share a single optical fiber 140. The central office 110 uses band pass filters corresponding respectively to the subscribers 120-1, 120-2, 120-N to pass respective signals from the subscribers, thereby discriminating respective information of the subscribers.

However, as well known in the art, in the SCMA optical network 100, optical beat interference (OBI) occurs if an optical receiver in the central office 110 simultaneously receives two or more optical signals. If OBI noise is present in the band of subcarrier signals, the OBI noise reduces the Signal to Noise Ratio (SNR).

Generally, OBI noise occurs when a single optical receiver receives two or more optical signals. The central frequency of OBI noise corresponds to the difference between the central frequencies of the two optical signals, and the spectrum of the OBI noise has a form similar to that of the convolution of the spectrums of the two optical signals. OBI noise occurs in the SCMA optical network since a single optical receiver in the SCMA optical network simultaneously receives a plurality of optical signals. Specifically, if the difference between the central frequencies of the two optical signals is within the band of subcarrier signals, OBI noise occurs in the band of subcarrier signals, reducing the signal to noise ratio (SNR). In order to guarantee signal quality in the SCMA optical network 100, it is especially important to rapidly detect occurrence of OBI noise and to find and control a light source causing the OBI noise.

In the conventional SCMA optical network 100, an OBI-causing light source is found in the following manner. The wavelength of the light source of the first subscriber 120-1 among the plurality of light sources is incrementally shifted (i.e., shifted little by little at fixed intervals) within a given range of wavelengths, and a noise power in the output from an optical receiver in the central office 110 is measured each time the wavelength is shifted. Then, the wavelength of the light source of the first subscriber 120-1 is adjusted to a wavelength at which a minimum noise power is measured. This procedure is performed sequentially for all light sources of the remaining subscribers 120-2, . . . , 120-N. That is, instead of directly finding an OBI-causing light source, the conventional method uses an indirect scheme in which a wavelength, at which a minimum noise power is measured in the output from an optical receiver in the central office, is found for all light sources.

However, the conventional OBI-causing light source detection method has the following problems. Since the conventional method uses a polling scheme such that the central wavelength of each subscriber light source is incrementally shifted within a specific range of wavelengths and the same procedure is performed for the next light source, it takes a long time to control OBI noise in some cases. For example, let us assume that the total number of light sources transmitting optical signals to the central office is 10 and the first to ninth of the ten light sources sequentially transmit optical signals. When a noise power output from an optical receiver in the central office is measured while incrementally shifting the central wavelength of the first light source within a given range of wavelengths in a polling scheme, the tenth subscriber is attempting to perform communication by turning on its light source (i.e., the tenth light source) and the tenth light source oscillates at a wavelength near the central wavelength of the ninth light source due to influence of external temperature or degradation of temperature measurement and control elements, thereby causing OBI noise in the output of the optical receiver in the central office. However, since the conventional method uses a polling scheme, the conventional method can perform the wavelength shifting procedure for the tenth light source only after completing the wavelength shifting procedure for all the first to ninth light sources. Thus, it takes a long time to find and control an OBI-causing light source. Further, since the wavelengths of OBI-free light sources, which do not cause OBI, are also shifted, even the OBI-free light sources can cause interference with other light sources.

UK Patent Publication No. GB2294372, which was published on Apr. 24, 1996, has disclosed an optical network that measures an OBI noise power and controls each light source in order to prevent occurrence of OBI noise. However, this prior art has not suggested a detailed method for effectively controlling each light source using the measured OBI noise.

### SUMMARY OF THE INVENTION

Therefore, the present invention has been made in view of the above problems, and it is an object of the present invention to provide an apparatus and method for rapidly detecting an OBI-causing light source among all light sources that transmit optical signals to a single optical receiver in a central office in an SCMA optical network in order to prevent degradation of the overall system performance due to OBI noise occurring when the single optical receiver receives two or more optical signals.

In accordance with one aspect of the present invention, the above and other objects can be accomplished by the provision of an apparatus for detecting a light source causing OBI in a subcarrier multiple access (SCMA) optical network, the apparatus comprising: a plurality of subcarrier power meters for measuring respective powers of subcarrier signals, corresponding respectively to a plurality of subscribers, obtained by filtering a multiplexed optical signal transmitted from a plurality of corresponding subscriber terminals in the SCMA optical network; an optical beat interference (OBI) power meter for measuring OBI noise power from an output of an optical receiver that receives the multiplexed optical signal and a noise occurrence determination unit for performing a control operation to sequentially change output powers of light sources provided in the plurality of subscriber terminals if a minimum signal to noise ratio (SNR) of SNRs between the powers of the subcarrier signals measured by the subcarrier power meters and the OBI noise power measured by the OBI power meter is less than a predetermined reference value, and determining that a light source among the light sources, which causes a change in the OBI noise power in response to the change in the output power of the light source, is an OBI-causing light source.

In accordance with another aspect of the present invention, there is provided a SCMA optical network system comprising: a plurality of subscriber terminals for modulating input signals using unique subcarriers allocated respectively to the subscriber terminals and transmitting optical signals carrying the modulated signals; an optical coupler for multiplexing the optical signals transmitted from the plurality of subscriber terminals into an optical signal; a central office for performing a control operation to sequentially change output powers of a plurality of light sources provided in the plurality of subscriber terminals if a minimum SNR of SNRs between powers of a plurality of subcarrier signals included in the multiplexed optical signal and an OBI power is less than a predetermined reference value, and determining that a light source among the light sources, which causes a change in the OBI power in response to the change in the output power of the light source, is an OBI-causing light source.

In accordance with yet another aspect of the present invention, there is provided a method for detecting a light source causing OBI in a subcarrier multiple access (SCMA) optical network, the method comprising the steps of: a) measuring respective powers of subcarrier signals, corresponding respectively to a plurality of subscribers, obtained by filtering a multiplexed optical signal transmitted from a plurality of corresponding subscriber terminals in the SCMA optical network; b) measuring OBI noise power from an output of an optical receiver that receives the multiplexed optical signal; and c) performing a control operation to sequentially change output powers of light sources provided in the plurality of subscriber terminals if a minimum signal to noise ratio (SNR) of SNRs between the measured powers of the subcarrier signals and the measured OBI noise power is less than a predetermined reference value, and determining that a light source among the light sources, which causes a change in the OBI noise power in response to the change in the output power of the light source, is an OBI-causing light source.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a general Subcarrier Multiple Access (SCMA) optical network;

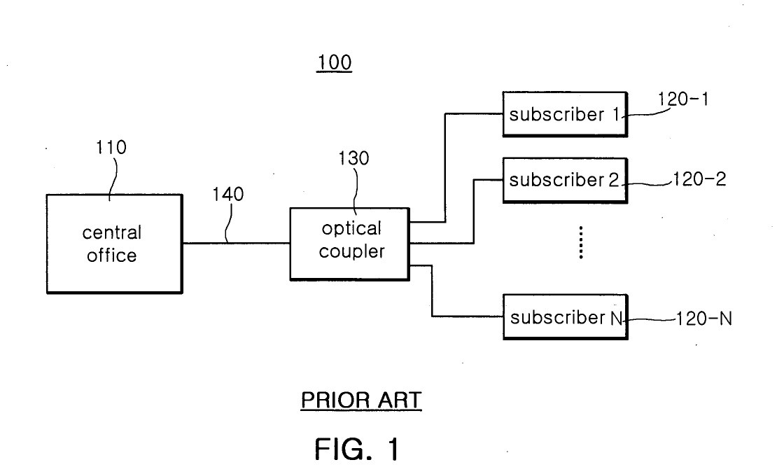

FIG. 2 is a block diagram of an SCMA optical network system and an apparatus for detecting a light source causing OBI according to an embodiment of the present invention; and

FIG. 3 is a flow chart of a method for detecting light sources causing OBI noise in an SCMA optical network system according to an embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description of the present invention, a detailed description of known functions and configurations incorporated herein will be omitted when it may obscure the subject matter of the present invention.

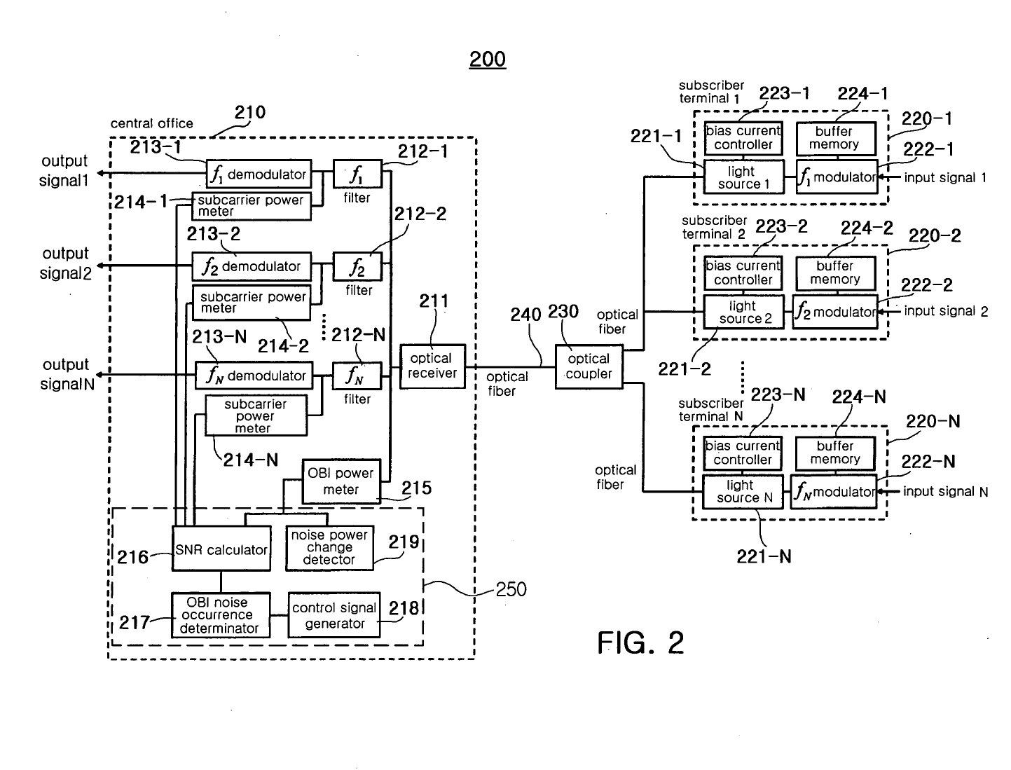

FIG. 2 is a block diagram of a Subcarrier Multiple Access (SCMA) optical network system and an apparatus for detecting a light source causing OBI according to an embodiment of the present invention.

As shown in FIG. 2, the SCMA optical network system 200 according to the embodiment of the present invention includes a plurality of subscriber terminals 220-1, 220-2, . . . 220-N, an optical coupler 230, and a central office 210. The subscriber terminals 220-1, 220-2, . . . 220-N modulate input signals using unique subcarriers f₁ to f_{N} allocated respectively to the subscriber terminals and transmit optical signals carrying the modulated signals. The optical coupler 230 multiplexes the optical signals transmitted from the plurality of subscriber terminals 220-1, 220-2, 220-N. The central office 210 includes an apparatus for detecting OBI-causing light sources, which detects light sources causing OBI among light sources 221-1, 221-2, . . . 221-N of the plurality of subscriber terminals 220-1, 220-2, 220-N on the basis of OBI power and respective powers of subcarrier signals transmitted from the subscriber terminals 220-1, 220-2, . . . 220-N. The optical coupler 230 and the central office 210 are connected through a single optical fiber 240.

The subscriber terminals 220-1, 220-2, . . . 220-N include the light sources 221-1, 221-2, . . . 221-N, modulators 222-1, 222-2, . . . 222-N, bias current controllers 223-1, 223-2, . . . 223-N, and buffer memories 224-1, 224-2, . . . 224-N.

The light sources 221-1, 221-2, . . . 221-N output light having unique wavelengths for the subscriber terminals 220-1, 220-2, . . . 220-N.

The modulators 222-1, 222-2, 222-N modulate input signals to the subscriber terminals 220-1, 220-2, . . . 220-N through unique subcarriers f₁ to f_{N} allocated respectively to the subscriber terminals 220-1, 220-2, . . . 220-N using the light sources 221-1, 221-2, . . . 221-N.

The bias current controllers 223-1, 223-2, . . . 223-N provide bias currents to the light sources 221-1, 221-2, . . . 221-N and are capable of controlling respective output powers of the light sources 221-1, 221-2, . . . 221-N under control of the central office 210.

The buffer memories 224-1, 224-2, . . . 224-N temporarily store signals input to the subscriber terminals 220-1, 220-2, . . . 220-N while the bias currents from the bias current controllers 223-1, 223-2, . . . 223-N are changed under control of the central office 210. After the change of the bias currents is finished, the buffer memories 224-1, 224-2, . . . 224-N retrieve and transmit the input signals temporarily stored therein to the central office 210.

The optical coupler 230 multiplexes optical signals transmitted from the plurality of subscriber terminals 220-1, 220-2, 220-N and then transmits the multiplexed optical signal to the central office 210 through the optical fiber 240.

The central office 210 includes an optical receiver 211, a plurality of filters 212-1, 212-2, . . . 212-N, a plurality of demodulators 213-1, 213-2, . . . 213-N, and the OBI-causing light source detection apparatus according to the present invention.

The optical receiver 211 is connected to the optical fiber 240 to receive an optical signal multiplexed and transmitted via the optical coupler 230. The filters 212-1, 212-2, . . . 212-N filter the multiplexed optical signal on a subscriber-by-subscriber basis to pass subcarrier signals f₁ to f_{N} allocated respectively to the subscribers. A band pass filter can be used as each of the filters 212-1, 212-2, 212-N. The demodulators 213-1, 213-2, . . . 213-N demodulate the filtered signals from the filters 212-1, 212-2, . . . 212-N using the subcarrier signals f₁ to f_{N} allocated respectively to the subscribers and output respective information transmitted from the subscribers (output signals 1 to N). The OBI-causing light source detection apparatus detects light sources causing OBI noise in the SCMA optical network system 200. A more detailed description will now be given of the OBI-causing light source detection apparatus.

The OBI-causing light source detection apparatus according to the present invention includes a plurality of subcarrier power meters 214-1, 214-2, . . . 214-N, an OBI power meter 215, and a noise occurrence determination unit 250.

The subcarrier power meters 214-1, 214-2, . . . 214-N are allocated respectively to the filters 212-1, 212-2, . . . 212-N, i.e., respectively to the subcarrier channels f₁ to f_{N}. The subcarrier power meters 214-1, 214-2, . . . 214-N measure respective powers of the subcarrier signals f₁ to f_{N} from the filtered signals, which have been passed through the filters 212-1, 212-2, . . . 212-N on a subscriber-by-subscriber basis.

The OBI power meter 215 measures OBI noise power from the output of the optical receiver 211 that receives the multiplexed optical signal. The noise occurrence determination unit 250 includes a signal-to-noise ratio (SNR) calculator 216, an OBI noise occurrence determinator 217, a control signal generator 218, and a noise power change detector 219. If the minimum SNR of SNRs between the subcarrier signal powers measured by the subcarrier power meters 214-1, 214-2, . . . 214-N and the OBI noise power measured by the OBI power meter 215 is less than a predetermined reference value, the noise occurrence determination unit 250 performs a control operation to sequentially change the output powers of the light sources 221-1, 221-2, . . . 221-N provided in the subscriber terminals 220-1, 220-2, . . . 220-N, and determines that a light source, which causes a change in the OBI noise power in response to the change in the output power, is an OBI-causing light source.

More specifically, the SNR calculator 216 receives output power values of the subcarrier power meters 214-1, 214-2, . . . 214-N and an output OBI power value of the OBI power meter 215 and calculates SNRs of the subcarrier channels.

The OBI noise occurrence determinator 217 receives the minimum SNR of the SNRs of the subcarrier channels from the SNR calculator 216, and compares the minimum SNR with a predetermined reference SNR to determine whether or not OBI noise has occurred.

If the OBI noise occurrence determinator 217 determines that OBI noise has occurred, the control signal generator 218 transmits a control signal to change the bias currents of the subscriber light sources 221-1, 221-2, . . . 221-N in a desired manner to the light sources 221-1, 221-2, . . . 221-N. For example, if the OBI noise occurrence determinator 217 determines that OBI noise has occurred, the control signal generator 218 may transmit a control signal to reduce the bias current of a light source 223 in a corresponding subscriber terminal 220 and increase the bias current thereof after a predetermined time to the corresponding subscriber terminal 220.

The noise power change detector 219 receives the measured power value from the OBI power meter 215 and determines whether or not a change has occurred in the noise power.

The SCMA optical network system 200 according to the present invention operates in the following manner. An output from the optical receiver 211 in the central office 210 is passed through the filters 212-1, 212-2, . . . 212-N that pass only signals in the corresponding subcarrier bands. Powers of the subcarrier signals passed through the filters 212-1, 212-2, . . . 212-N are measured through the subcarrier power meters 214-1, 214-2, . . . 214-N and OBI noise at this time is measured through the OBI power meter 215. The SNR calculator 216 receives the output power values of the subcarrier power meters 214-1, 214-2, . . . 214-N and the output power value of the OBI noise power meter 215, and calculates SNRs of the subcarrier channels and then outputs the minimum SNR of the calculated SNRs. The OBI noise occurrence determinator 217 receives the minimum subcarrier SNR output from the SNR calculator 216 and compares the received minimum subcarrier SNR with a predetermined reference SNR. The reference SNR must be set larger than that in which the subcarrier signals satisfy a desired signal quality. If the result of the comparison is that the minimum subcarrier SNR is less than the reference SNR, the OBI noise occurrence determinator 217 determines that OBI noise has occurred and activates the control signal generator 218. The activated control signal generator 218 transmits a control signal to reduce the bias current of the first light source 221-1 in the first subscriber terminal 220-1 and increase the bias current thereof after a predetermined time to the first subscriber terminal 220-1. When the first subscriber terminal 220-1 receives the control signal, the bias current controller 223-1 in the first subscriber terminal 220-1 reduces the bias current of the first light source 221-1 and increases the bias current thereof after a predetermined time. Here, while constantly monitoring the power value measured by the OBI power meter 215, the noise power change detector 219 in the central office 210 detects a change in the noise power in which the noise power is reduced and increased. If such a change has occurred, it is determined that the current light source (i.e., the first light source 221-1) is an OBI-causing light source. If such a change has not occurred, it is determined that the first light source 221-1 is not an OBI-causing light source. If the procedure of the first light source 221-1 is finished, the control signal generator 218 in the central office 210 transmits a control signal to reduce the bias current of the second light source in the second subscriber terminal 220-2 and increase the bias current thereof after a predetermined time to the second subscriber terminal 220-2. When the second subscriber terminal 220-2 receives the control signal, the bias current controller 223-2 in the second subscriber terminal 220-2 reduces the bias current of the second light source 221-2 and increases the bias current thereof after a predetermined time. In the same manner as described above, while constantly monitoring the power value measured by the OBI power meter 215, the noise power change detector 219 in the central office 210 detects a change in the noise power in which the noise power is reduced and increased. If such a change has occurred, it is determined that the second light source 221-2 is an OBI-causing light source. If such a change has not occurred, it is determined that the second light source 221-2 is not an OBI-causing light source. This procedure is sequentially applied to the remaining light sources, thereby detecting all OBI-causing light sources.

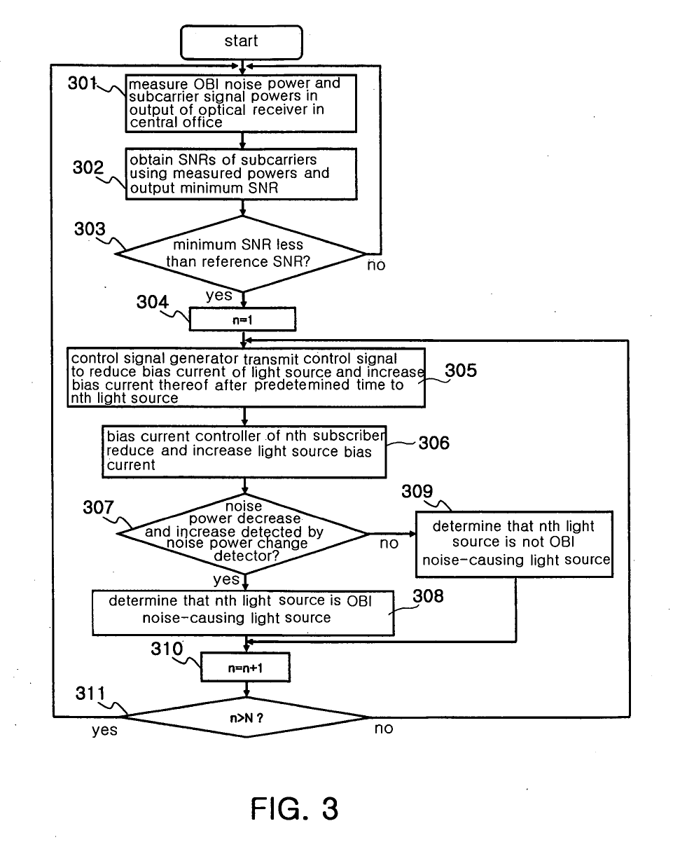

FIG. 3 is a flow chart of a method for detecting light sources causing OBI noise in an SCMA optical network system according to an embodiment of the present invention.

Referring to FIG. 3, the subscriber terminals 220-1, 220-2, . . . 220-N modulate input signals using unique subcarriers allocated respectively to the subscriber terminals 220-1, 220-2, . . . 220-N and transmit optical signals carrying the modulated signals. The optical signals are multiplexed via the optical coupler 230 and then transmitted to the central office 210. The central office 210 receives the multiplexed optical signal through the optical receiver 211, and filters the received optical signal through the filters 212-1, 212-2, . . . 212-N to pass subcarrier signals allocated respectively to the filters 212-1, 212-2, . . . 212-N. Then, the subcarrier power meters 214-1, 214-2, . . . 214-N measure powers of the subcarrier signals passed through the filters 212-1, 212-2, . . . 212-N, and the OBI power meter 215 measures an OBI noise power from the received optical signal (step 301).

The SNR calculator 216 receives the respective power values of the subcarrier signals and the OBI noise power value, and calculates SNRs of all subcarrier signals and outputs the minimum SNR of the SNRs of all subcarrier signals (step 302).

Then, the OBI noise occurrence determinator 217 compares the minimum SNR with a predetermined reference SNR. If the minimum SNR is larger than the reference SNR, it is determined that no OBI noise has occurred, the procedure returns to step 301. If the minimum SNR is equal to or less than the predetermined SNR, it is determined that OBI noise has occurred, and the procedure proceeds to step 304.

At step 304, a light source order index n representing the order of the light sources is reset to 1. Here, the index value 1 indicates the first light source 221-1.

Then, the control signal generator 218 in the central office 210 generates a control signal to change the bias current of the nth light source 221-1 in a desired manner and transmits the generated control signal to the nth light source 221-1 (step 305). The control signal may include a control signal to reduce the bias current of the nth light source and increase the bias current thereof after a predetermined time.

After receiving the control signal, the subscriber terminal 220-1 decreases the bias current of the light source 221-1 and increases the bias current thereof after a predetermined time through the bias current controller 223-1 (step 306). Preferably, in order to prevent loss of input information during the change of the bias current of the bias current controller 223-1 under the control of the central office 210, the method further includes the step of temporarily storing signals input to the subscriber terminals 220-1, 220-2, 220-N in the buffer memories 224-1, 224-2, . . . 224-N during the change of the bias current and transmitting the stored input signals to the central office 210 when the bias current returns to the original level.

If the bias current of the light source 221-1 in the subscriber terminal 220-1 is reduced and increased and thus the optical output power for transmission is reduced and increased, the noise power change detector 219 in the central office 210 determines whether or not there is a change in the OBI noise power. If there is a change in the measured noise power, it is determined that the nth light source 221-1 is a light source causing OBI noise. If there is no change in the measured noise power, it is determined that the nth light source 221-1 is a light source not causing OBI noise (steps 307, 308 and 309).

Next, the light source order index n is increased by one to set a new index n indicating the next light source 221-2 (i.e., n=n+1) (step 310). Then, the new index n is compared with a total light source number N representing the number of light sources 221-1, 221-2, . . . 221-N that transmit optical signals to the optical receiver 211 in the central office 210. If the light source order index is larger than the total light source number N, the procedure returns to step 301, and if the light source order index is equal to or less than the total light source number N, the procedure returns to step 306 (step 311). In this manner, it is possible to determine whether or not the light sources 221-1, 221-2, . . . 221-N in all subscriber terminals 220-1, 220-2, . . . 220-N cause OBI.

As is apparent from the above description, an apparatus and method for detecting a light source causing optical beat interference (OBI) noise in a subcarrier multiple access (SCMA) optical network according to the present invention has an advantage in that it is possible to rapidly find an OBI-causing light source when OBI noise occurs in the SCMA optical network. According to the present invention, light source control for OBI noise reduction is required only for the found OBI-causing light source, so that OBI noise can be rapidly reduced, thereby providing excellent system performance.

The method for detecting light sources causing OBI noise in an SCMA optical network system according to the present invention can be embodied as computer readable code on a computer readable medium. The computer readable medium is any data storage device that stores data which can be read by a computer system. Examples of the computer readable medium include read-only memory (ROM), random-access memory (RAM), CD-ROM, magnetic tape, floppy disk, optical data storage devices, and so on. The computer readable medium can also be embodied in the form of carrier waves as signals communicated over the Internet. The computer readable medium can also be distributed over a network of coupled computer systems so that the computer readable code is stored and executed in a distributed fashion.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention should not be limited to the embodiments described above but defined by the accompanying claims and equivalents thereof.

What is claimed is:

1. An apparatus for detecting a light source causing OBI in a subcarrier multiple access (SCMA) optical network, the apparatus comprising:
a plurality of subcarrier power meters for measuring respective powers of subcarrier signals, corresponding respectively to a plurality of subscribers, obtained by filtering a multiplexed optical signal transmitted from a plurality of corresponding subscriber terminals in the SCMA optical network;
an optical beat interference (OBI) power meter for measuring OBI noise power from an output of an optical receiver that receives the multiplexed optical signal; and
a noise occurrence determination unit for performing a control operation to sequentially change output powers of light sources provided in the plurality of subscriber terminals if a minimum signal to noise ratio (SNR) of SNRs between the powers of the subcarrier signals measured by the subcarrier power meters and the OBI noise power measured by the OBI power meter is less than a predetermined reference value, and determining that a light source among the light sources, which causes a change in the OBI noise power in response to the change in the output power of the light source, is an OBI-causing light source.

2. The apparatus according to claim 1, wherein the noise occurrence determination unit includes:
an SNR calculator for obtaining SNRs of a plurality of subcarrier channels using output values of the plurality of subcarrier power meters and an output value of the OBI power meter;
an OBI noise occurrence determinator for receiving a minimum SNR of the SNRs of the plurality of subcarrier channels from the SNR calculator, and comparing the minimum SNR with a predetermined reference value to determine whether or not OBI noise has occurred;
a control signal generator for transmitting a control signal to change bias currents of the light sources provided in the subscriber terminals in a desired manner to the subscriber terminals if the OBI noise occurrence determinator determines that OBI noise has occurred; and
a noise power change detector for receiving a noise power value measured by the OBI power meter and determining whether or not a change has occurred in the noise power.

3. The apparatus according to claim 2, wherein, if the OBI noise occurrence determinator determines that OBI noise has occurred, the control signal generator transmits a control signal to reduce the bias currents of the light sources and increase the bias currents thereof after a predetermined time to the subscriber terminals.

4. An SCMA optical network system comprising:
a plurality of subscriber terminals for modulating input signals using unique subcarriers allocated respectively to the subscriber terminals and transmitting optical signals carrying the modulated signals;
an optical coupler for multiplexing the optical signals transmitted from the plurality of subscriber terminals into an optical signal;
a central office for performing a control operation to sequentially change output powers of a plurality of light sources provided in the plurality of subscriber terminals if a minimum SNR of SNRs between powers of a plurality of subcarrier signals included in the multiplexed optical signal and an OBI power is less than a predetermined reference value, and determining that a light source among the light sources, which causes a change in the OBI power in response to the change in the output power of the light source, is an OBI-causing light source.

5. The SCMA optical network system according to claim 4, wherein each of the subscriber terminals includes:
a light source;
a modulator for modulating a signal input to the subscriber terminal through a unique subcarrier allocated to the subscriber terminal using the light source;
a bias current controller for providing a bias current to the light source, the bias current controller being capable of controlling an output power of the light source under control of the central office; and
a buffer memory for temporarily storing the input signal while the bias current from the bias current controller is changed under control of the central office.

6. The SCMA optical network system according to claim 5, wherein, after the change of the bias current by the bias current controller is finished, the buffer memory retrieves and transmits the temporarily stored input signal to the central office.

7. The SCMA optical network system according to claim 4, wherein the central office includes:
a plurality of filters for separating the multiplexed optical signal transmitted from the plurality of subscriber terminals into subcarrier signals allocated respectively to a plurality of subscribers corresponding respectively to the plurality of subscriber terminals in an SCMA optical network;
a plurality of subcarrier power meters for measuring respective powers of the subcarrier signals;
an OBI power meter for measuring an OBI noise power from an output of an optical receiver that receives the multiplexed optical signal; and
a noise occurrence determination unit for performing a control operation to sequentially change output powers of light sources provided in the subscriber terminals if a minimum SNR of SNRs between the powers of the subcarrier signals measured by the subcarrier power meters and the OBI noise power measured by the OBI power meter is less than a predetermined reference value, and determining that a light source among the light sources, which causes a change in the OBI noise power in response to the change in the output power of the light source, is an OBI-causing light source.

8. The SCMA optical network system according to claim 7, wherein the noise occurrence determination unit includes:
an SNR calculator for obtaining SNRs of a plurality of subcarrier channels using output values of the plurality of subcarrier power meters and an output value of the OBI power meter;
an OBI noise occurrence determinator for receiving a minimum SNR of the SNRs of the plurality of subcarrier channels from the SNR calculator, and comparing the minimum SNR with a predetermined reference value to determine whether or not OBI noise has occurred;
a control signal generator for transmitting a control signal to change bias currents of the light sources provided in the subscriber terminals in a desired manner to the subscriber terminals if the OBI noise occurrence determinator determines that OBI noise has occurred; and
a noise power change detector for receiving a noise power value measured by the OBI power meter and determining whether or not a change has occurred in the noise power.

9. A method for detecting a light source causing OBI in a subcarrier multiple access (SCMA) optical network, the method comprising the steps of:
a) measuring respective powers of subcarrier signals, corresponding respectively to a plurality of subscribers, obtained by filtering a multiplexed optical signal transmitted from a plurality of corresponding subscriber terminals in the SCMA optical network;
b) measuring OBI noise power from an output of an optical receiver that receives the multiplexed optical signal; and
c) performing a control operation to sequentially change output powers of light sources provided in the plurality of subscriber terminals if a minimum signal to noise ratio (SNR) of SNRs between the measured powers of the subcarrier signals and the measured OBI noise power is less than a predetermined reference value, and determining that a light source among the light sources, which causes a change in the OBI noise power in response to the change in the output power of the light source, is an OBI-causing light source.

10. The method according to claim 9, wherein the step c) includes the steps of:
c-1) obtaining SNRs of a plurality of subcarrier channels using respective powers of the plurality of subcarrier signals and the OBI noise power;
c-2) comparing a minimum SNR of the SNRs of the plurality of subcarrier channels with a predetermined reference value to determine whether or not OBI noise has occurred;
c-3) transmitting a control signal to change a bias current of a light source provided in a specific subscriber terminal in a desired manner to the specific subscriber terminal if the result of the determination of the step c-2) is that OBI noise has occurred; and
c-4) determining that the specific subscriber terminal is an OBI-causing light source if an output from the specific subscriber terminal, which is changed according to the control signal, causes a change in the OBI noise power.

11. The method according to claim 9, wherein the step c) is performed sequentially for all the light sources provided in the plurality of subscriber terminals.

12. The method according to claim 9, wherein the step c) includes the steps of:
temporarily storing a signal input to the subscriber terminal during the change of the output power of the light source in the subscriber terminal; and
transmitting the stored input signal when the output power of the light source in the subscriber terminal returns to an original level.
